(19) United States
(12) Patent Application Publication
(10) Pub. No.: US 2009/0252918 A1
(43) Pub. Date: Oct. 8, 2009

(54) SANDWICH MATERIAL

(75) Inventor: Nicolaas Jan Franciscus van Der Mark, Delft (NL)

Correspondence Address: LUCAS & MERCANTI, LLP, 475 PARK AVENUE SOUTH, 15TH FLOOR, NEW YORK, NY, 10016, US

(73) Assignee: L-SIM B.V., Den Haag (NL)

(21) Appl. No.: 12/095,193

(22) PCT Filed: Nov. 27, 2006
(86) PCT No.: PCT/NL06/00594

§ 371 Date: Sep. 22, 2008

(30) Foreign Application Priority Data
Nov. 28, 2005 (NL) 1030545
Sep. 15, 2006 (NL) 1032516

(51) Int. Cl. B32B 3/12; B32B 38/10

(52) U.S. Cl. 428/116; 156/256

(57) ABSTRACT

The invention relates to a sandwich material comprising two top layers and a core material, wherein the core material is built up from a sandwich material consisting of layers of thermoplastic honeycomb material which are connected to each other by means of fiber reinforced plastic layers and wherein said plastic layers are at right angles relative to said top layers, and to a method for manufacturing such sandwich material.

The invention relates to a sandwich material. Sandwich materials are known and usually consist of a core, mostly a honeycomb material, and two top layers. With this construction, a material is obtained that is lightweight and has a good rigidity. Through variation of the nature of the core and the top layers, the properties of the sandwich material can be adapted to a certain extent.

As a rule, sandwich materials have a reasonable to good compression strength, but really high values cannot be achieved. There is however a need for plate materials or sandwich materials which combine a small weight with high compression strength. Here, so-called prop plates can be involved; plates that are used under props of a crane or other heavy vehicle.

When such a vehicle has to move, load or unload a heavy load, often, legs or props are spread out for its stabilisation. For the protection of the road surface and for support of the prop, a plate is placed underneath. When four legs are used for a vehicle with a bearing capacity of 50 tons, this therefore amounts to an average weight of 12.5 tons per plate. As, during use, the weight is often not equally distributed over the props, the load per plate can increase to over 35 tons. Generally, it can be stated that the load can increase to 70% of the lift weight. Heretofore, for these plates, use has been made of various materials, such as bamboo, wood, steel sections, compressed plastic, recycling granulate and the like.

A drawback of these plates is the great weight thereof. This is disadvantageous firstly because, as a result, the effective loading capacity of the vehicle during transport is smaller as the weight of the plates is to the detriment of the effective loading capacity of the vehicle, because of the legal limitation of the total weight of the vehicle. Secondly, the consequence may be that due to European legislation with regard to maximum axle pressure, and possible uneven distribution of the plates and the load, the loading capacity can be utilized less effectively. Finally, a great weight is disadvantageous from an ergonomic viewpoint. The heavy plates form a load for the employees that have to lift and place them under the props.

It is, therefore, an object of the invention to provide a sandwich material that, on the one side, is much lighter in weight than the current plates of steel, aluminum or plastic and can therefore be handled more easily and, on the other side, has a very high compression strength and flexural rigidity so that it can be used as a prop plate. However, during use of a prop plate, it is also important that it has a certain elasticity, in order to adequately compensate for irregularities and inclination in the underground, without permanent deformation or even breakage of the plate being involved.

The invention is based on the surprising insight that it is possible to provide a sandwich material based on a honeycomb material that still has a very high compression strength. It has appeared that by placing a large number of layers of thermoplastic honeycomb material attached onto each other at right angles onto the top layers, i.e., turned 90% relative to the top layers, a material is obtained with a very high compression strength and flexural rigidity. By choosing a thermoplastic material, also, the desired elasticity is then obtained which is required for the (temporary) deformation.

The invention therefore also relates to a sandwich material comprising two top layers and a core material, wherein the core material is built up from a sandwich material, consisting of two layers of thermoplastic honeycomb material which are interconnected by means of fiber reinforced plastic layers and wherein the plastic layers are at right angles relative to the top layers.

The sandwich material according to the invention can be manufactured by applying onto each other layers of thermoplastic honeycomb material with intermediate layers of fiber reinforced plastic, while this layer also provides the adhesion between layers of honeycomb material, sawing the material through at right angles to the layers of fiber reinforced plastic for obtaining a core material having the desired thickness, and providing the top layers onto the core material.

The materials that are used for manufacture can be conventional products also used for manufacturing conventional sandwich materials. The core material is based on a thermoplastic honeycomb material. The honeycomb material is manufactured from a thermoplastic material, preferably selected from the group consisting of polyolefins, styrene polymers, polycarbonates and polyphenylene ether resins, more particularly polypropylene, polyethylene and polycarbonate. Most preferred is the use of polypropylene.

The layers of honeycomb material are connected to each other by means of a layer of a fiber reinforced plastic, preferably a glass fibre impregnated with a thermosetting plastic such as an epoxy resin, a urethane resin or an unsaturated polyester resin. The thickness of these layers, i.e. the height of the honeycomb material, is preferably between 0.3 and 1.5 cm, more particularly between 0.5 and 1.0 cm, while it is important that with higher values, the maximum compression strength and flexural rigidity are smaller.

The block thus built-up from layers of honeycomb material is sawed through perpendicular to the plane of the fiber reinforced plastic layers and, on the sawed surfaces, the top layers are fastened. Depending on the desired dimensions, a number of the sawed-off plates can be provided side by side between the top layers.

The top layers preferably also consist of fiber reinforced plastics, such as glass fiber fleece with epoxy resin. These top layers can simply be adhered to the sawed surfaces with the aid of a thermosetting resin, for instance an epoxy resin or a glue, such as a polyurethane glue.

In case the plates are not of a square shape, it is preferred that the layers of honeycomb material be parallel to the longest side of the sandwich material because thus, the best properties are obtained.

The thus obtained sandwich material can be compared as regards weight to current sandwich materials but has a compression strength and flexural rigidity that are more than adequate for the use as prop plate, and which has evident advantages with respect to the materials normally used for prop plates, such as steel, wood or recycling plastic.

The thickness of the material depends on the desired use and the desired rigidity of the material. A preferred thickness is between 0.5 and 15 cm, preferably between 2 and 12 cm. It is noted that a higher value for the thickness surprisingly leads to a higher compression strength.

The dimensions of the plates can vary within very broad limits. The minimum dimension both in length and in width is 10 cm, while the maximum value therefore can be 250 cm or more.

The compression strength of the materials according to the invention is easily 2 kg/cm² or more. Current values are between 25 and 115 kg/cm² or more. This strength can further be varied by adjusting the thickness of the glass fiber between the honeycomb layers and/or the height of the honeycomb material. Use of a more limited height of the honeycomb material gives a higher compression strength.

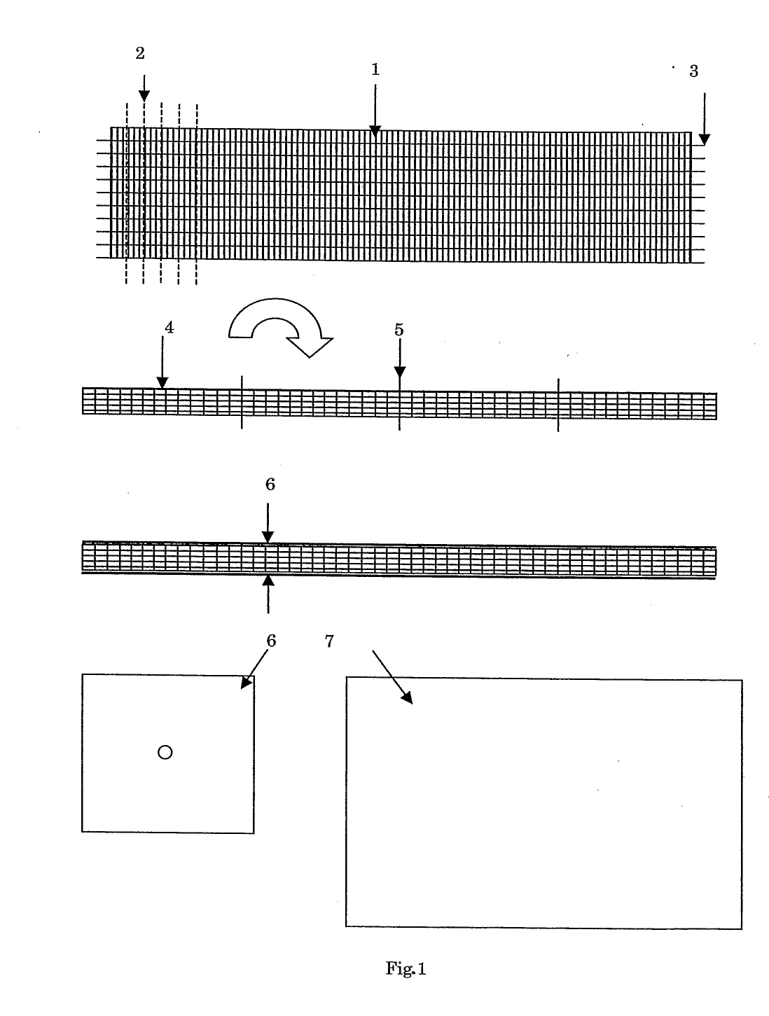

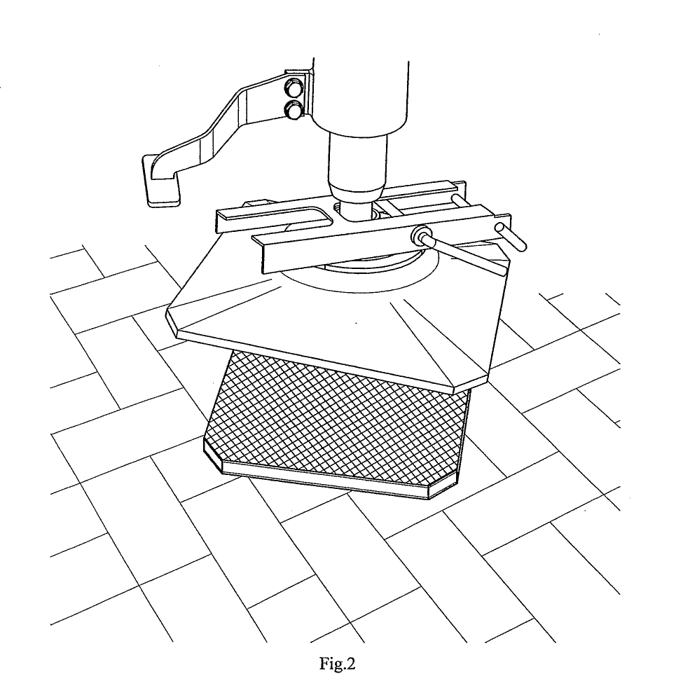

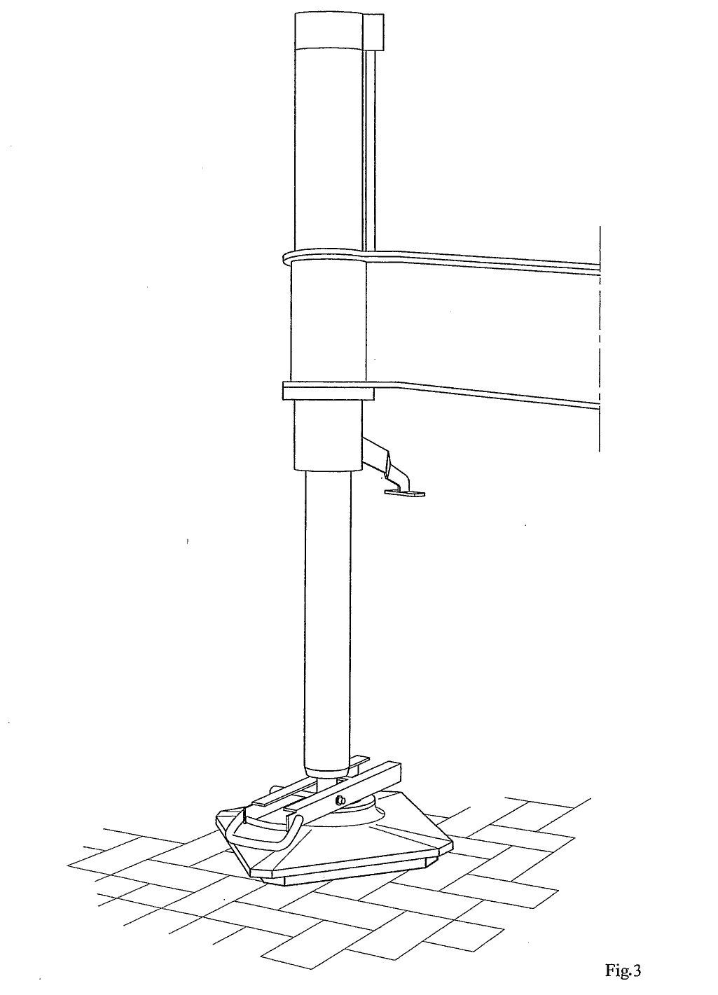

The invention is further specified on the basis of a drawing, wherein, in FIG. 1, schematically, the manufacture of a sandwich material according to the invention has been depicted, and, in FIG. 2, the placing of a prop plate under the prop is shown and, in FIG. 3, a detail of the prop is shown with, underneath it, the prop plate according to the invention.

In FIG. 1, reference numeral 1 refers to a polypropylene honeycomb core, which consists of glass fiber fabric reinforcing layers (3) which are impregnated with a thermosetting (epoxy) resin. Saw cuts (2) are provided over the entire width of the glued sandwich block (1). The sawed parts (4) are tilted over 90°. The glue seams (5) are therefore perpendicular to the length of the material.

Glass fiber fabric skins (6) are then anchored on or connected to the tilted reinforced honeycomb material (4).

Under 7, two variants of the prop plate formed are shown, viz. a square plate and a rectangular plate. The dimensions of the plate according to the invention can be between 10 cm and 300 cm or more. Examples of such dimensions of prop plates are, for a square plate, 390×390 mm or 500×500 mm and, for a rectangular plate, 1000×800 mm, 2000×1000 mm or 2400×1200 mm.

In FIG. 2 is shown how the plate according to the invention is provided under the base plate (prop) of a crane, while FIG. 3 shows a detail of the prop with, underneath it, the prop plate according to the invention.

1. Sandwich material comprising two top layers and a core material, wherein the core material is built-up from a sandwich material, consisting of layers of a thermoplastic honeycomb material which are connected to each other by means of fiber reinforced plastic layers and wherein said plastic layers are at right angles relative to said top layers.

2. Sandwich material according to claim 1, wherein the thermoplastic honeycomb material is manufactured from a material selected from the group consisting of polyolefins, styrene polymers, polycarbonates and polyphenylene ether resins, more particularly polypropylene, polyethylene and polycarbonate.

3. Sandwich material according to claim 1, wherein the top layers consist of fiber reinforced plastic, more particularly cured epoxy resin.

4. Sandwich material according to claim 1, wherein the fiber reinforcement consists of glass fiber fabric.

5. Sandwich material according to claim 1, wherein the thickness of the core material is between 0.5 and 15 cm, preferably between 2 and 12 cm.

6. Sandwich material according to claim 1, wherein the height of said honeycomb material is between 0.3 and 1.5 cm, preferably between 0.5 and 1.0 cm.

7. Sandwich material according to claim 1, wherein the fiber reinforced plastic layers in the core material consist of epoxy resin and glass fiber fabric.

8. A prop plate for supporting legs of heavy transport means, cranes and the like, consisting of a sandwich material according to claim 1.

9. A prop plate according to claim 8, with a compression strength of at least 2 kg/cm² preferably at least 25 kg/cm².

10. A method for manufacturing a sandwich material according to claim 1, comprising applying onto each other layers of thermoplastic honeycomb material with intermediate layers of fiber reinforced plastic, which layer also provides the adhesion between layers of honeycomb material, sawing the material through at right angles to the layers of fiber reinforced plastic for obtaining a core material with the desired thickness, and applying said top layers on the core material.

11. A method according to claim 10, wherein so many layers of honeycomb material with intermediate layers of fiber reinforced plastic are applied onto each other until the height of the material at least corresponds to the width of the desired sandwich material.

12. Sandwich material obtainable utilizing the method according to claim 10.
